(19) United States
(12) Patent Application Publication
(10) Pub. No.: US 2003/0141147 A1
(43) Pub. Date: Jul. 31, 2003

(54) Modified modular ladder with removable rungs

(76) Inventor: Timothy Scott Skipper, Ormond Beach, FL (US)

Correspondence Address: John Wiley Horton, Pennington, Moore, Wilkinson, Bell & Dunbar, P.A., 2nd Floor, 215 S. Monroe St., Tallahassee, FL, 32301, US

(21) Appl. No.: 10/162,022

(22) Filed: Jun. 4, 2002

Related U.S. Application Data
(63) Continuation-in-part of application No. 10/058,901, filed on Jan. 30, 2002.

(51) Int. Cl. E06C 9/00

(52) U.S. Cl. 182/100

(57) ABSTRACT

A ladder incorporating a vertical support structure and a set of removable rungs. The vertical support structure is formed by stacking a series of interlocking sticks. The sticks incorporate features allowing the removable installation of the rungs. The rungs are small and light, so that a set of such rungs may be easily carried by a user. The vertical sticks generally remain attached to the object to be climbed—such as a tree or pole. When the user wishes to climb the object, the user installs the rungs as he or she climbs. The rungs are then removed upon descent. In this manner, unauthorized climbing of the object is inhibited. Locking features are also included to prevent unauthorized access by another person having a set of removable rungs. Several different embodiments of the removable rungs are disclosed. The application of the invention to different types of hunting tree stands is also disclosed in detail, although the application of the invention extends far beyond hunting products.

### CROSS-REFERENCES TO RELATED APPLICATIONS

This application is a continuation in part of application Ser. No. 10/058,901, having a filing date of Jan. 30, 2002 (also naming Timothy Scott Skipper as sole inventor).

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of ladders. More specifically, the invention comprises a modular ladder having removable steps.

2. Description of the Related Art

The incorporation of removable rungs into various structures is well known in the prior art. As one example, U.S. Pat. No. 6,247,553 to Jones (2001) discloses a removable rung (or step) designed to be applied to a steel T-post of the type commonly used for cattle fencing. It allows a user to step over a modem fence line without having to put weight on the strands of barbed wire. The Jones device is not easily removable, however. It is designed to be installed and left in place. Thus, it is ill suited for the type of application encompassed by the present invention.

U.S. Pat. No. 3,833,090 to Georgianna (1974) discloses a removable step designed to be locked into a steel support column. This invention is directed to warehouse racks, whose vertical columns already include slots for the mounting of shelves and the like. The step design in the '090 patent takes advantage of these pre-existing slots. The step is quite large and cumbersome, however. It would be difficult to store a set of such steps on the user's person, and quite cumbersome to carry them over long distances.

A similar device is disclosed in U.S. Pat. No. 4,450,936 to Strom (1984). The Strom device also takes advantage of the pre-existing slots found in warehouse columns. Unlike the Georgianna device, though, it is formed of simple bar stock components. The '936 device should therefore be easier to fabricate. It is still quite bulky, however. In addition, it requires a support column having a large interior cavity so that the step can be “snaked” into position. While such a large cavity is often found in warehouse columns, it is rarely found elsewhere.

Accordingly, the prior art devices are limited in that they:

1. Are difficult to apply and remove;

2. Are heavy;

3. Are bulky; and

4. Require a vertical column having a large interior cavity. Require the deployment

### BRIEF SUMMARY OF THE INVENTION

A ladder is composed of a vertical support structure and a set of rungs. In the present invention, the vertical support structure is formed by stacking a series of interlocking sticks. The sticks incorporate features allowing the removable installation of a set of rungs. The rungs are small and light, so that a set of such rungs may be easily carried by a user. The vertical sticks generally remain attached to the object to be climbed—such as a tree or pole. When the user wishes to climb the object, the user installs the rungs as he or she climbs. The rungs are then removed upon descent. In this manner, unauthorized climbing of the object is inhibited.

Several different embodiments of the removable rungs are disclosed. The common feature of all these embodiments is the fact that the rungs cannot come loose from the vertical stick while they are under load (some embodiments cannot come loose, whether loaded or not). The application of the invention to different types of hunting tree stands is also disclosed in detail, although the application of the invention extends far beyond hunting products.

A locking mechanism, which allows the user to lock the device in a position where it cannot be climbed by an unauthorized user, is also provided.

### BRIEF DESCRIPTION OF THE SEVERAL VIEWS OF THE DRAWINGS

FIG. 1 is an isometric view, showing a prior art tree stand and ladder.

FIG. 2 is an isometric view, showing a prior art climbing stick in greater detail.

FIG. 3 is an isometric view, showing the vertical support element of the proposed invention.

FIG. 4 is an isometric view, showing the details of the angled holes piercing the vertical support element.

FIG. 4B is an isometric view, showing the alternating nature of the angled holes in the vertical support element.

FIG. 5 is an isometric view, showing a removable rung.

FIG. 6 is an isometric view, showing the installation of a removable rung.

FIG. 7 is an isometric view, showing the installation of a removable rung.

FIG. 8 is an isometric view, showing the installation of a removable rung.

FIG. 9 is an elevation view, showing the installation of a removable rung.

FIG. 10 is an elevation view, showing the installation of a removable rung.

FIG. 11 is an isometric view, showing the removable rungs in place on the vertical support element.

FIG. 12 is an isometric view, showing two of the vertical support elements stacked together, with rungs attached.

FIG. 13 is an isometric view, showing the vertical support elements attached to a tree.

FIG. 14 is an isometric view, showing the details of the base stick.

FIG. 15 is an isometric view, showing the locking slide.

FIG. 16 is an isometric view, showing the operation of the locking mechanism.

FIG. 17 is an isometric view, showing the operation of the locking mechanism.

FIG. 18 is an isometric view, showing an alternate embodiment of the removable rung.

REFERENCE NUMBERALS IN THE DRAWINGS

| | |
|---|---|
| 10 | tree |
| 12 | tree stand |
| 14 | climbing stick |
| 16 | fixed rung |
| 18 | securing strap |
| 20 | standoff |
| 26 | inclined hole |
| 30 | strap lock |
| 38 | removable rung |
| 40 | step |
| 42 | insertion cylinder |
| 52 | ladder stand |
| 56 | base |
| 60 | transverse hole |
| 90 | lock hole |
| 96 | pierced stick |
| 98 | strap anchor |
| 100 | extension |
| 102 | receptacle |
| 104 | admission slot |
| 106 | leading protrusion |
| 108 | trailing protrusion |
| 110 | first side wall |
| 112 | second side wall |
| 114 | base stick |
| 116 | locking handle |
| 118 | locking hole |
| 120 | slot |
| 122 | locking slide |
| 124 | inclined notch |
| 126 | horizontal hole |
| 128 | alternate rung |

### DETAILED DESCRIPTION OF THE INVENTION

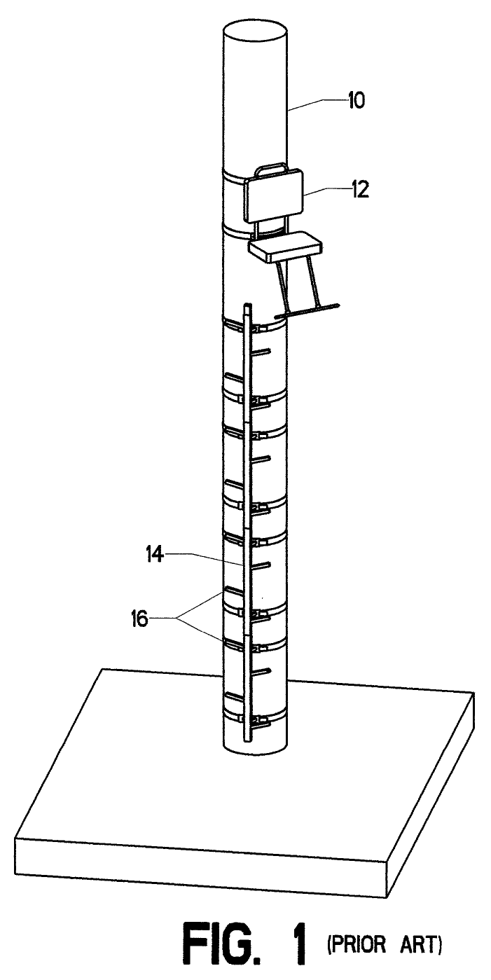

The proposed invention allows a user to climb many types of vertical objects. One particular application of the invention is in the field of hunting, where tree stands are often employed to provide the hunter an elevated and stationary position. FIG. 1 shows a prior art tree stand 12 attached to a tree 10. As installing a tree stand requires considerable effort, hunters often wish to leave them in place. This requires a device for climbing the tree. FIG. 1 also discloses a prior art tree-climbing device. A series of climbing sticks 14 are linked together and attached to tree 10. Each climbing stick 14 has a series of fixed rungs 16.

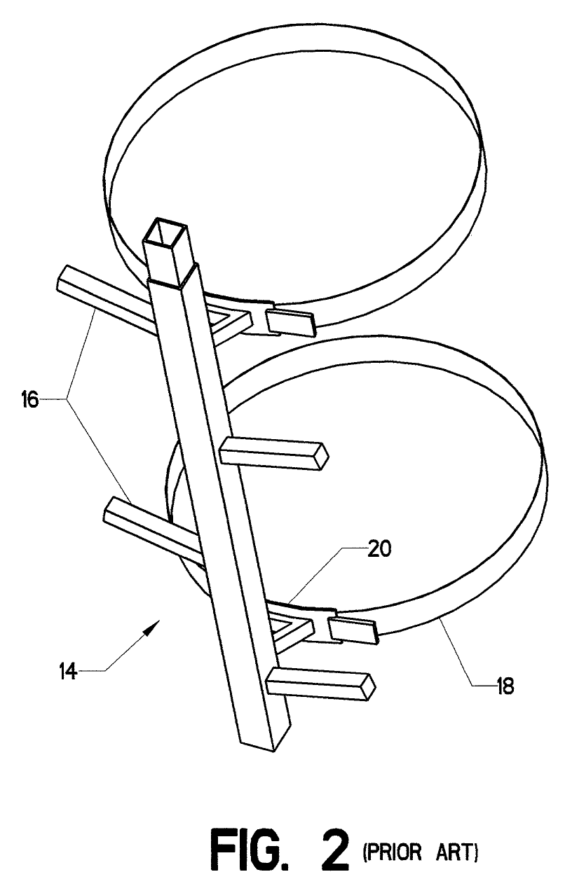

FIG. 2 shows an individual climbing stick 14 in more detail. The reader should be aware that the square vertical member is hollow, so that a second climbing stick 14 can be placed on top of the one shown and linked together using the smaller square section located on top of the climbing stick 14. Two stand offs 20 are provided to separate climbing stick 14 from the tree 10, thereby allowing clearance for the user's boots on fixed rungs 16. A pair of securing straps 18 are passed tightly around the tree 10 and locked in position by toggle clamps or other prior art means.

The prior art devices shown in FIGS. 1 and 2 are effective in allowing access to the tree stand 12. Unfortunately, when the user leaves the tree stand 12 unattended, other persons may use the ready access to steal the tree stand. In addition, many landowners are concerned about the safety of unsecured ladders in position on their property. If children or persons unfamiliar with tree climbing climb the unsecured ladders, they may be injured. Thus, it is desirable to create a ladder which cannot be climbed without specialized equipment.

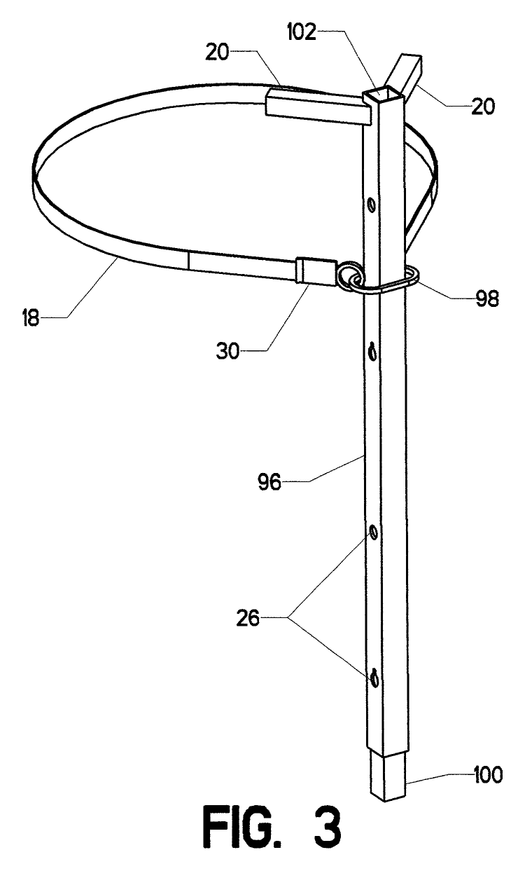

FIG. 3 discloses one embodiment of the present invention. Pierced stick 96 is similar in its general configuration to the prior art climbing stick 14, except that it includes no fixed rungs 16. Two stand offs 20 are provided, along with securing strap 18, which is attached via strap anchor 98. Strap 18 is locked in place around the object to be climbed by actuating strap lock 30.

Pierced stick 96 incorporates features allowing a series of such sticks to be assembled vertically. The lower portion of the device incorporates extension 100. The upper portion encompasses, via the hollow nature of the material used, receptacle 102. Those skilled in the art will readily appreciate that a second pierced stick 96 could be mated to the one shown in FIG. 3 via inserting the extension 100 of the second pierced stick 96 into the receptacle 102 of the pierced stick 96 shown. Additional pierced sticks 96 could then be added to create a column of desired height.

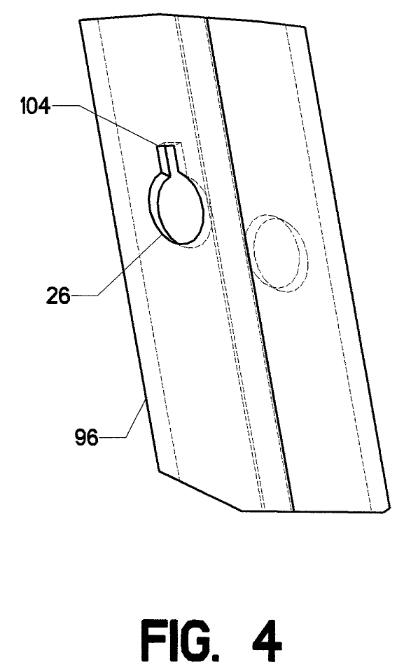

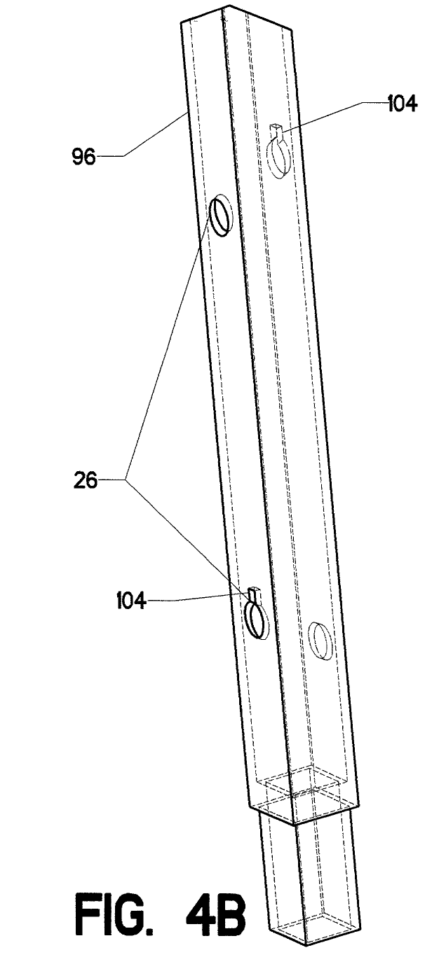

The vertical support column of pierced stick 96 is modified over the prior art. Like the prior art device, it is formed primarily of a hollow square section. However, it is also pierced by a series of inclined holes 26. FIG. 4 shows a detailed view of one of these inclined holes 26. The reader will observe that they are substantially inclined from the horizontal. In addition, one side of the hole incorporates admission slot 104.

FIG. 4B shows another view of pierced stick 96. The reader will observe that alternating inclined holes 26 are actually inclined in opposite directions. In addition, the admission slots 104 alternate as well, with admission slot 104 being always located on the upper extreme of inclined hole 26. The reasons underlying these features will be explained in the following.

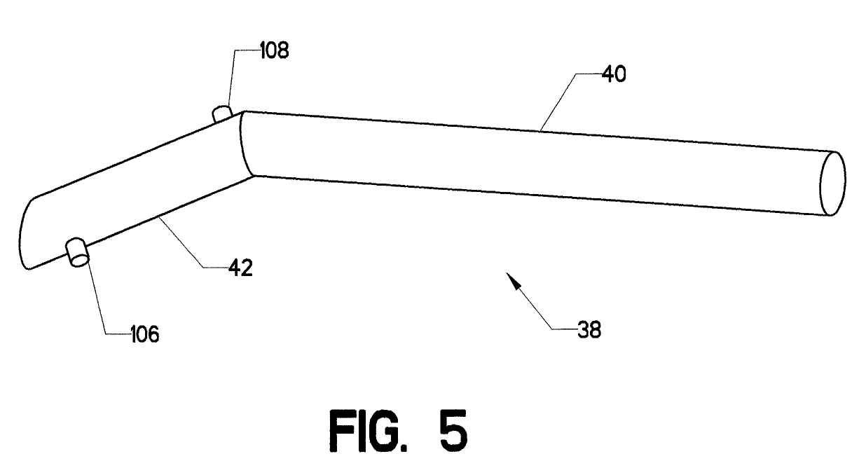

FIG. 5 shows removable rung 38. It comprises two main components: insertion cylinder 42 and step 40. Insertion cylinder 42 includes two protrusions, separated by linear distance and 180 degrees of rotation. The first of these, leading protrusion 106, descends from the lower extreme of insertion cylinder 42, just aft of its leading end (the right-hand extreme, in the view shown). The second of these, trailing protrusion 108, ascends from the upper extreme of insertion cylinder 42, near where it joins step 40.

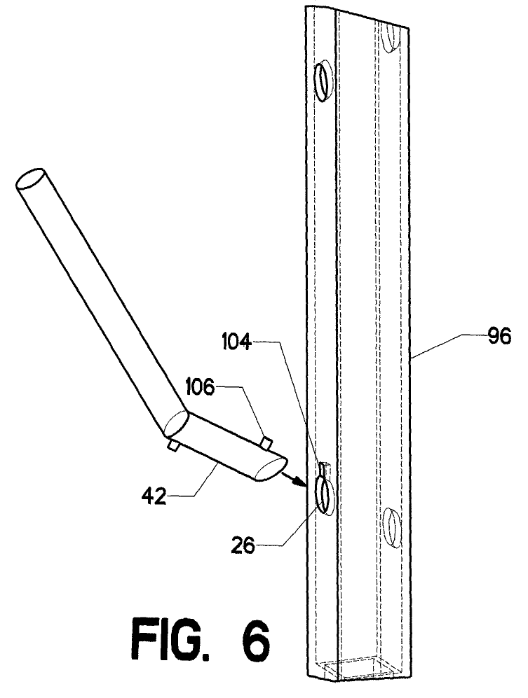

FIGS. 6 through 8 illustrate the sequence of inserting removable rung 38 into pierced stick 96. First, removable rung 38 is inverted by rotating insertion cylinder 42 180 degrees. The reader will observe that leading protrusion 106 is now extending upwards. This orientation allows leading protrusion 106 to pass through admission slot 104 and into the interior of pierced stick 96 (which, as explained previously, is hollow). The user then advances insertion cylinder 42 into the hollow interior until trailing protrusion 108 comes up against the outer surface of pierced stick 96.

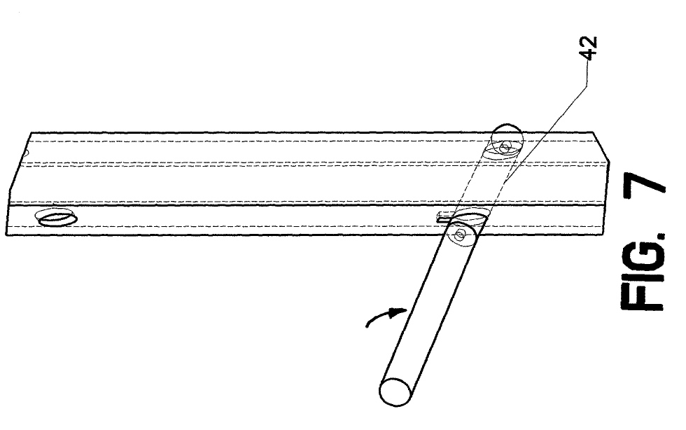

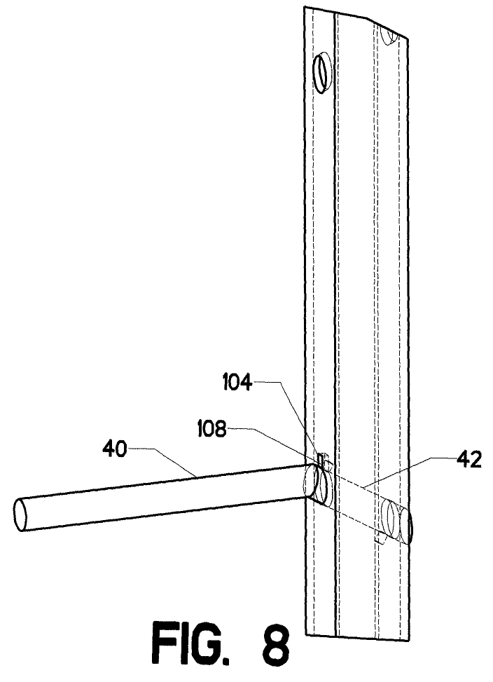

Next, as shown in FIG. 7, the user rotates removable rung 38 (in either direction) 180 degrees, so that trailing protrusion 108 aligns with admission slot 104. The user then advances insertion cylinder 42 further into inclined hole 26—as shown in FIG. 8

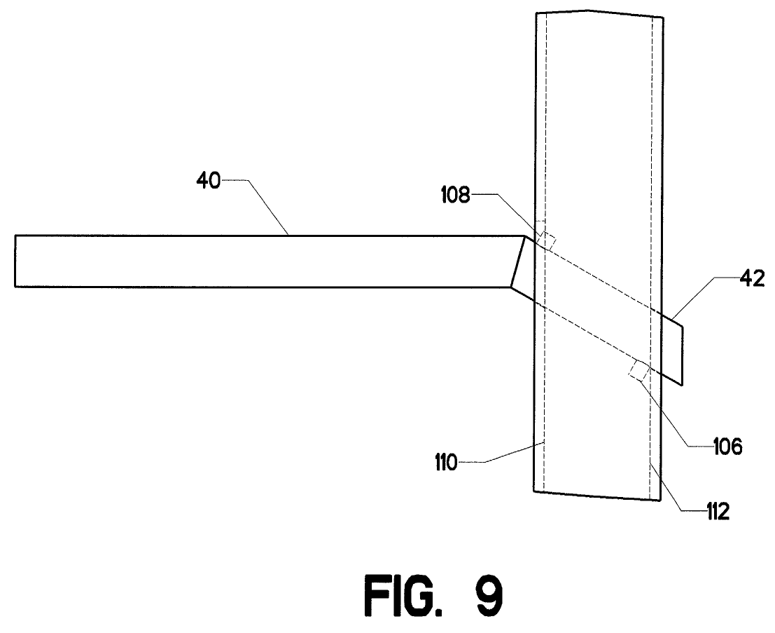

Turning now to FIG. 9, the reader will observe that further progress of insertion cylinder 42 through inclined hole 26 has been arrested by the fact that leading protrusion 106 has come up against second side wall 112 (where admission slot 104 was found in first side wall 110). Second side wall 112 has no admission slot—it only has the inclined hole. Thus, the removable rung is locked in place.

The geometry of removable rung 38 reveals that it is locked in place under load. The reader will also observe, however, that trailing protrusion 108 rests within admission slot 104. Thus, whether loaded or not, removable rung 38 is restrained from rotating and is thereby locked in place. Only through deliberate manipulation is it possible to remove it

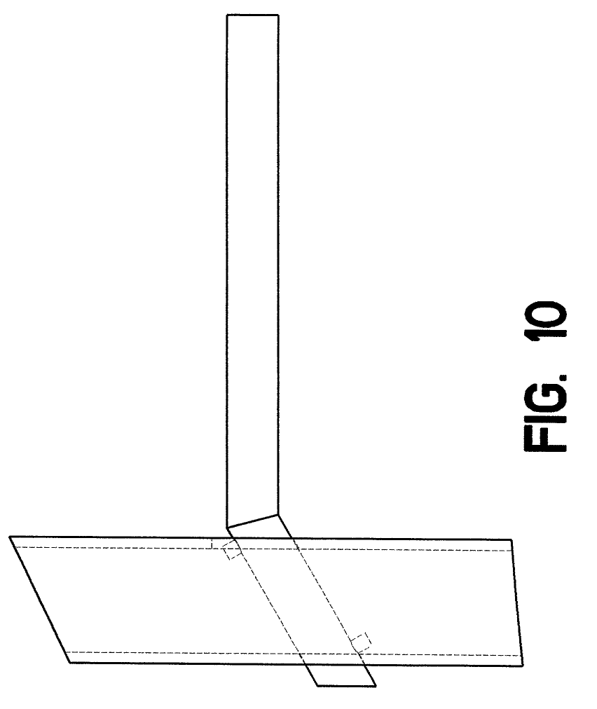

Step 40 extends out from the side of pierced stick 26 Since it forms the stepping surface for a user climbing the device, it may be knurled or coated with a non-slip surface to promote traction. As illustrated previously in FIG. 4B, successive inclined holes 26 are actually inclined in opposite directions. This alternating orientation is provided so that alternating steps can be inserted on opposite sides of pierced stick 26. FIG. 10 shows an elevation view of a removable rung 38 inserted from the right-hand side (in the view as shown). The reader will observe that the inclined hole 26 shown is inclined in the opposite direction from the one shown in FIG. 9. Likewise, it has admission slot 104 located on second side wall 112 rather than first side wall 110. This mirror-imaging of the previously disclosed features allows removable rung 38 to be inserted from the right rather than the left. Removable rung 38 is absolutely identical; i.e., the same rung can be inserted from the right or the left, depending on the incline of inclined hole 26.

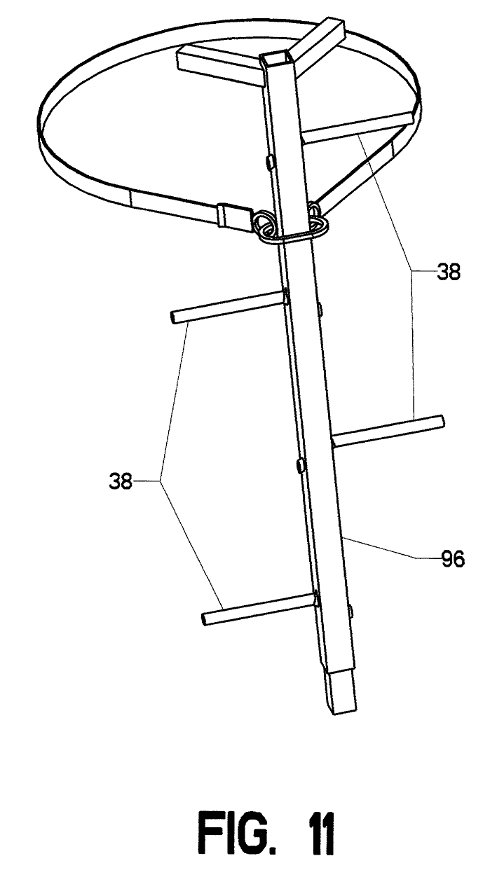

FIG. 11 shows pierced stick 96 with four removable rungs 38 locked in position. The reader will now understand why successive inclined holes 26 must be inclined in opposite directions in order to allow removable rungs 38 to be inserted in alternating sides.

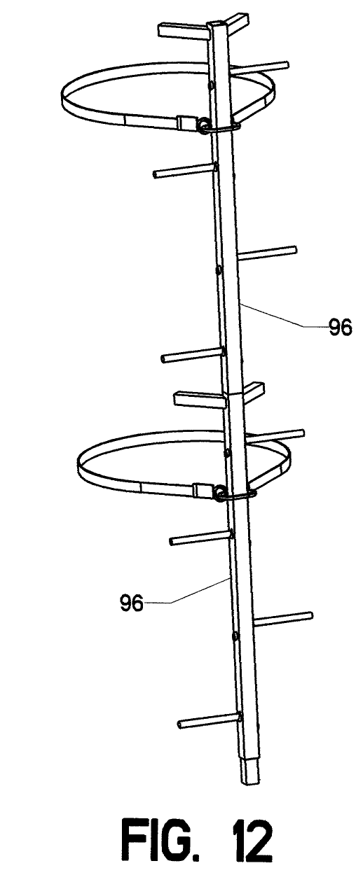

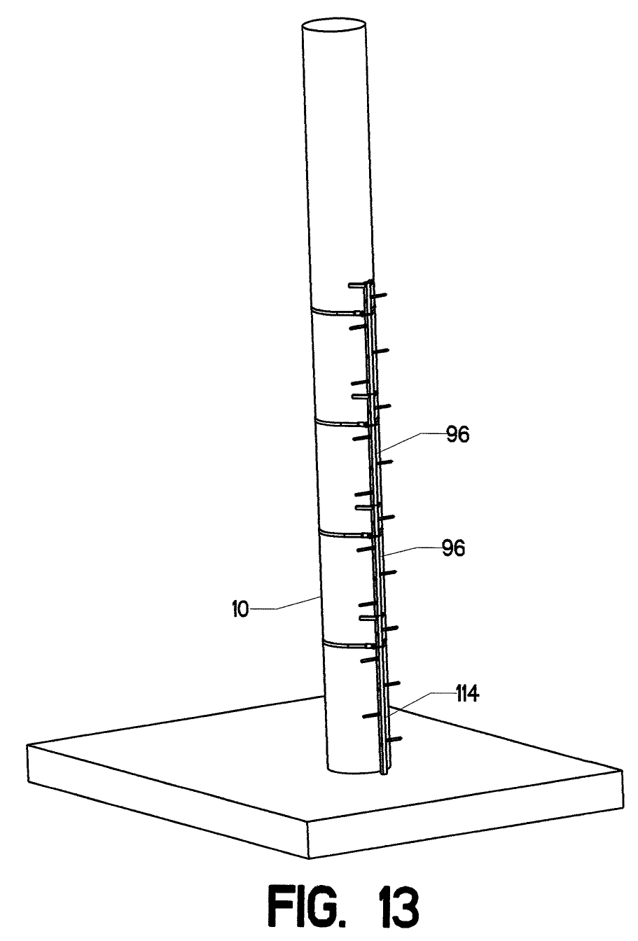

FIG. 12 shows two pierced sticks 96 locked together—as previously described. FIG. 13 shows a column of pierced sticks 96 attached to a vertical object to be climbed—in this case tree 10. Although a tree has been used for the illustration, those skilled in the art will realize that the invention can also be easily attached to utility poles, walls (using different attaching means), or other types of vertical objects.

In actual use, a stack of four or more pierced sticks 98 would be placed on the tree 10 or other object to be climbed. The sticks 98 are attached to the tree 10 using the securing straps 18 which are well known in the prior art. All removable rungs 38 would be removed before leaving the device unattended. A user wishing to climb the device would need to bring along a set of removable rungs 38. The user would then progressively install removable rungs 38 as he or she ascends the ladder. When the user later descends the ladder, removable rungs 38 would be progressively removed.

A rung to rung spacing of 9 to 18 inches is typical for this type of device. Accordingly, in order to ascend a twelve foot object, the user would need to bring approximately eight to sixteen removable rungs 38. These rungs 38 can be made of aluminum alloy, resulting in a modest weight, even for a set of sixteen.

FIG. 13 also discloses another type of vertical support element—base stick 114. Base stick 114 is not strictly necessary. A normal pierced stick 96 can be used instead. However, as it incorporates additional features, base stick 114 is desirable.

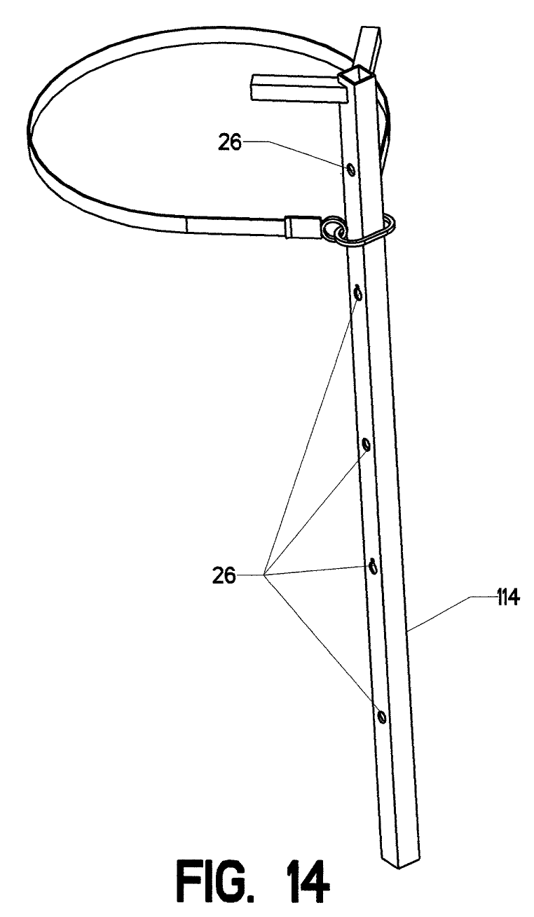

FIG. 14 shows base stick 114 in greater detail. The reader will observe that it is longer than pierced stick 96, encompassing one additional inclined hole 26. It also has a flat lower extreme (lacking the extension). This lower extreme is typically placed on the ground.

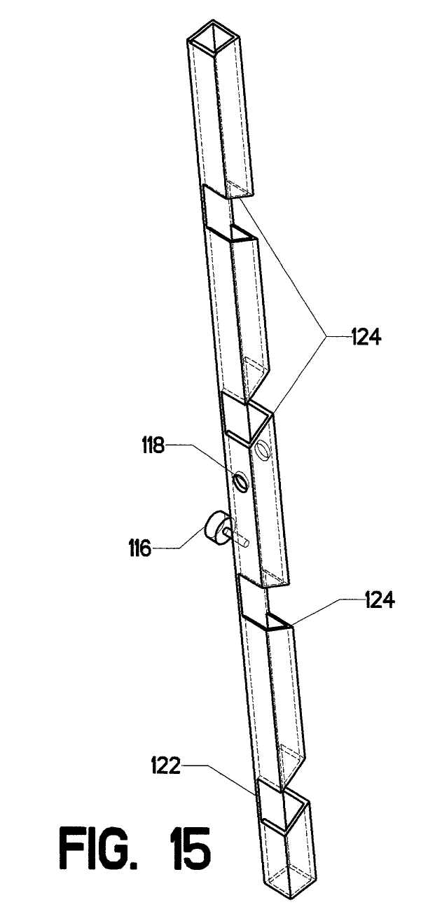

It is desirable to prevent unauthorized persons from using the invention to climb an object to which it is secured. Some unauthorized persons may have access to removable rungs 38. Thus, an additional security measure is advantageous. FIG. 15 discloses locking slide 122. It is also formed from a hollow square section. It is sized to slidably fit within the hollow interior of base stick 114. Locking slide 122 is cut by a series of inclined notches 124. Locking hole 118 also passes transversely through locking slide 122 (it is also inclined).

Locking handle 116 is attached to the rear surface of locking slide 122 It allows the user to move locking slide 122 up and down within the interior of base stick 114, as will be explained in the following.

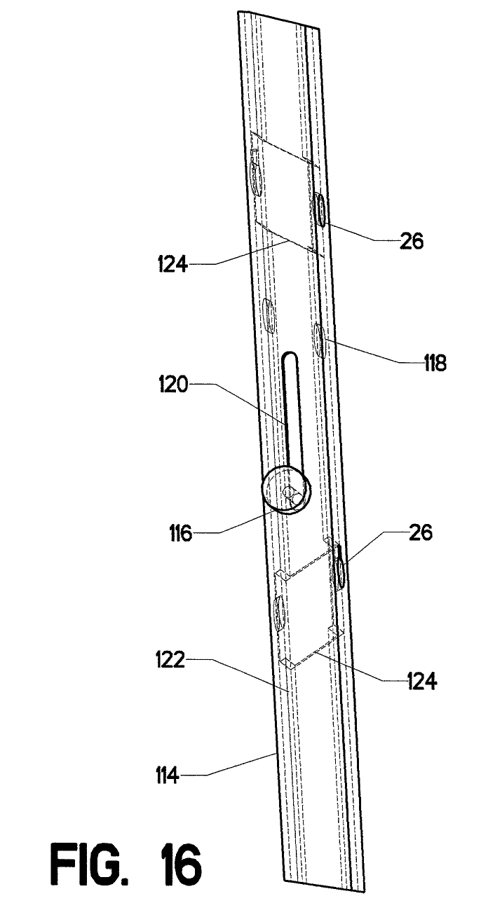

FIG. 16 is a hidden-line view showing locking slide 122 inside base stick 114. The reader will observe that inclined notches 124 within locking slide 122 align with inclined holes 26 in base stick 114. In the position shown, locking slide 122 does not interfere with the addition or removal of removable rungs 38. Thus, the position shown is the “unlocked” position.

Locking handle 116 passes through the rear wall of base stick 114 through slot 120. Of course, locking handle 116 must be made removable from locking slide 122 (such as by a threaded engagement), in order to allow assembly. During assembly, locking slide 122 is typically slipped into base stick 114. The threaded hole for receiving locking handle 116 is then aligned with slot 120. Locking handle 116 is then threaded into position, where it remains.

The view in FIG. 16 shows that locking hole 118 is positioned well below the upper inclined hole 26. Gravity maintains locking slide 122 in this position, by pulling locking handle 116 to the lower extreme of slot 120.

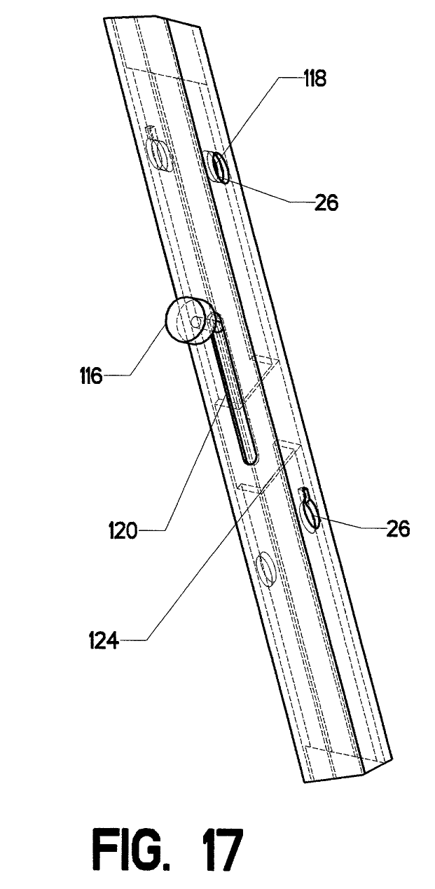

In FIG. 17, the user has grasped locking handle 116 and pulled locking slide 122 upward until locking handle 116 stops against the upper extreme of slot 120. The reader will observe that inclined notches 124 no longer align with inclined holes 26. In fact, the solid side walls of locking slide 122 now completely obstruct inclined holes 26 in base stick 114. This fact prevents the installation of any removable rungs 38, rendering the device inoperable. The reader will also observe that locking hole 118 in locking slide 122 now aligns with the upper inclined hole 26 (upper in this particular view). This fact allows a user to pass a lock through the aligned holes, thereby securing the device in an inoperative state.

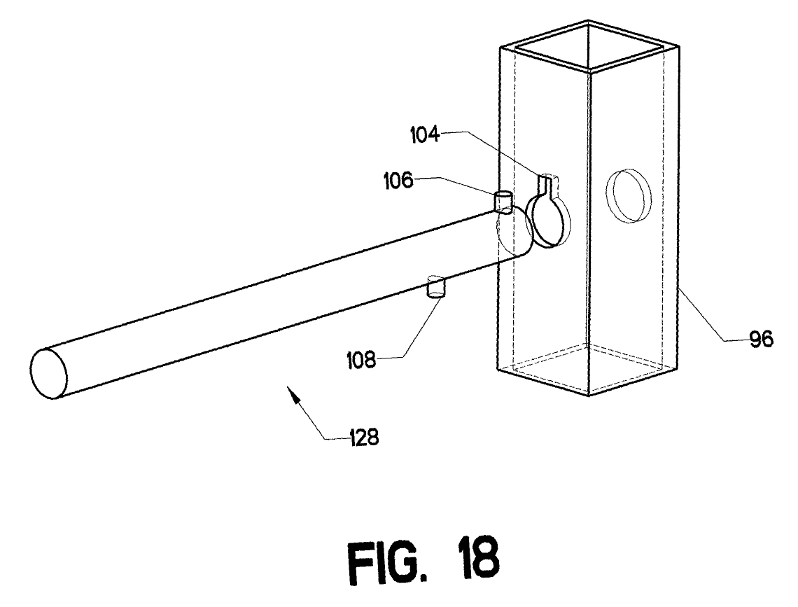

Although the use of the removable rung 38 having an inclined cylinder 42 is preferable, it is by no means the only manner of implementing the invention. FIG. 18 shows a simplified version employing a straight alternate rung 128. The hole through pierced stick 96, in the embodiment shown, is horizontal. Alternate rung 128 has leading protrusion 106 and trailing protrusion 108, again separated by distance and 180 degrees of rotation. To install alternate rung 128, the user aligns leading protrusion 106 with admission slot 104, then pushes the right-hand portion of the rung into the hollow interior of pierced stick 96. The user then rotates alternate rung 128 to align trailing protrusion 108 with admission slot 104. By this point, the right hand (in the view) portion of alternate rung 128 will be seated within the right hand hole in pierced stick 96.

The embodiments described have been modular; i.e., they can be broken down into reasonable short segments to aid portability. However, those skilled in the art will also realize that the invention could be made non-modular. As an example, a long version of pierced stick 96 (perhaps 20 feet long) could be bolted to a utility pole. Such a pierced stick 96 would have 26 or more inclined holes 26. The application of the device to a utility pole would prevent unauthorized climbing, while allowing service personnel to easily climb the pole. A long version of pierced stick 96 could also be attached to the vertical walls of manholes and other construction features.

Likewise, those skilled in the art will know that many hunting stands are free-standing—such as tripod stands. The removable rung features could be incorporated into one of the legs of the tripod. The removable rung features could also be incorporated into the legs of a ladder stand.

Although the preceding description contains significant detail, it should not be construed as limiting the scope of the invention but rather as providing illustrations of the preferred embodiment of the invention. Thus, the scope of the invention should be fixed by the following claims, rather than by the examples given.

Having described my invention, I claim:

1. A ladder having removable rungs, comprising:
a. a vertical support column having a first side wall, a second side wall, and a hole passing completely through said first side wall and said second side wall;
b. A removable rung, including an insertion cylinder sized to slidably fit within said hole, a step, and a leading protrusion extending outward from said insertion cylinder distal from said step; and
c. wherein said first side wall of said vertical support column opens into an admission slot proximate said hole, sized to allow said leading protrusion to slide therethrough, so that said removable rung can be inserted into said column by placing said insertion cylinder within said hole, sliding said leading protrusion through said admission slot, and advancing said insertion cylinder into said hole so that said leading protrusion eventually rests between said first side wall and said second side wall.

2. A ladder as recited in claim 1, further comprising locking means moveable between an unlocked position where said removable rung can be inserted in said column, and a locked position where said removable rung cannot be inserted in said column.

3. A ladder as recited in claim 2, wherein said locking means comprises:
a. a locking slide, slidably disposed with respect to said vertical support column, and having an unlocked position where said removable rung can be inserted in said column, and a locked position where said removable rung cannot be inserted in said column;
b. wherein said locking slide has a notch, positioned to align with said hole when said locking slide is in said unlocked position, and positioned to obstruct said hole when said locking slide is in said locked position; and
c. means for locking said locking slide in said locked position.

4. A ladder as recited in claim 1, wherein said hole has an intersection with said first side wall and an intersection with said second side wall, and wherein said intersection with said first side wall is higher than said intersection with said second side wall so that said hole is inclined from the horizontal.

5. A ladder as recited in claim 1, further comprising:
a. wherein said leading protrusion extends from said insertion cylinder in a position distal from said step;
b. a trailing protrusion, extending for said insertion cylinder in a position proximate said step; and
c. wherein said trailing protrusion is angularly offset from said leading protrusion, so that said removable rung can be inserted into said column by placing said insertion cylinder within said hole, sliding said leading protrusion completely through said admission slot, rotating said insertion cylinder in order to align said trailing protrusion with said admission slot, and advancing said insertion cylinder into said hole so that said trailing protrusion rests within said admission slot.

6. A ladder as recited in claim 4, further comprising:
a. wherein said leading protrusion extends from said insertion cylinder in a position distal from said step;
b. a trailing protrusion, extending from said insertion cylinder in a position proximate said step;
c. wherein said trailing protrusion is angularly offset from said leading protrusion, so that said removable rung can be inserted into said column by placing said insertion cylinder within said hole, sliding said leading protrusion completely through said admission slot, rotating said insertion cylinder in order to align said trailing protrusion with said admission slot, and advancing said insertion cylinder into said hole so that said trailing protrusion rests within said admission slot; and
d. wherein said step is angularly offset from said insertion cylinder so that said step is horizontal when said insertion cylinder is installed within said inclined hole.

7. A ladder as recited in claim 1, further comprising means for securing said ladder to an object to be climbed.

8. A ladder as recited in claim 2, further comprising means for securing said ladder to an object to be climbed.

9. A ladder as recited in claim 3, further comprising means for securing said ladder to an object to be climbed.

10. A ladder as recited in claim 4, further comprising means for securing said ladder to an object to be climbed.

11. A ladder as recited in claim 5, further comprising means for securing said ladder to an object to be climbed.

12. A ladder as recited in claim 6, further comprising means for securing said ladder to an object to be climbed.

13. A ladder which a user can attach to an object to be climbed, comprising:
a. a vertical support column;
b. means for attaching said vertical support column to said object to be climbed; and
c. a plurality of rungs, removably attached to said vertical support column, so that said user can install said plurality of rungs in order to ascend and descend said vertical support column, and remove said plurality of rungs in order to prevent unauthorized persons from ascending and descending said vertical support column.

14. A ladder as recited in claim 13, further comprising locking means moveable between an unlocked position where said removable rungs can be inserted in said column, and a locked position where said removable rungs cannot be inserted in said column.

15. A ladder as recited in claim 13, wherein said vertical support column is comprised of a plurality of shorter columns linked together.
